(19) United States
(12) Patent Application Publication
(10) Pub. No.: US 2009/0276549 A1
(43) Pub. Date: Nov. 5, 2009

(54) Access for host stacks

(75) Inventors: Christian Zechlin, Herne (DE); Andre Gleichner, Essen (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/151,129

(22) Filed: May 1, 2008

(51) Int. Cl. G06F 13/20

(52) U.S. Cl. 710/36; 710/51

(57) ABSTRACT

This invention relates to a method, a computer program product, a device, and a system for using one host controller by at least two host stacks and handling accesses to the host controller based on access rules.

### FIELD OF THE APPLICATION

This invention relates to a method, a computer program product, a device, and a system for at least two host stacks.

### BACKGROUND OF THE APPLICATION

Recently, the specification for a new Universal Serial Bus (USB) based Universal Integrated Circuits Card (UICC) terminal interface was approved by European Telecommunications Standards Institute (ETSI) Technical Committee (TC) Smart Card Platform (SCP) in ETSI TS 102 600. This specification is based on the Inter-Chip USB Supplement to the USB 2.0 Specification, Revision 1.0, Mar. 13, 2006. According to TS 102 600 the phone is the host and the UICC is the device.

This architecture implies that the device like the UICC can offer a number of services to the host like the phone; e.g. it can, very naturally, offer the service of a smart card according the USB smart card device class. In addition it can for example offer the services of a communication device (which allows Internet Protocol (IP) connectivity between the phone and the UICC), and/or the service of a mass storage device.

Thus, for instance, UICCs providing USB interchip interface might allow “normal”, transfer of Subscriber Identity Module (SIM) Application Protocol Data Units (APDUs) by means of using Smart Card class as well as access to a Mass Memory on a SIM card by means of using USB Mass Storage Class and/or IP access via USB.

In architectures, e.g. architectures of mobile devices, different engines have to access the UICC. For instance, in a mobile terminal a converged architecture may comprise a modem engine configured to perform phone functions and at least one further application engine for further function, wherein the modem engine will be accessing the UICC for the transfer of SIM APDUs, whereas applications residing on the at least one further engine will be accessing the UICC for transferring files or IP traffic.

### SUMMARY

According to a first aspect of the present invention, a method is described, comprising using one host controller by at least two host stacks and handling accesses to the host controller based on access rules.

According to a second aspect of the present invention, a device is described, comprising one host controller, at least two host stacks, and one multiplexing entity configured to use the one host controller by said at least two host stacks and configured to handle accesses to the host controller based on access rules.

According to a third aspect to the present invention, a system is described, wherein said system comprises a device as described above and an apparatus coupled to the host controller, wherein the host controller is configured to control data transmission between said at least two host stacks and the apparatus.

According to a fourth aspect of the present invention, a computer-readable storage medium encoded with instructions is described, that, when executed by a computer, perform: using one host controller by at least two host stacks and handling accesses to the host controller based on access rules.

According to a fifth aspect of the present invention, a computer program is described, the computer program comprising using one host controller by at least two host stacks and handling accesses to the host controller based on access rules.

According to a sixth aspect of the present invention, an information providing apparatus is described, comprising using one host controller by at least two host stacks and handling accesses to the host controller based on access rules.

According to a seventh aspect of the present invention, a device is described, the device comprising one host controller means, at least two host stack means, and one multiplexing means configured to use the one host controller means by said at least two host stack means and configured to handle accesses to the host controller means based on access rules.

The at least two host stacks and the multiplexing entity may be seen as functional entities, wherein these entities may be realized in hardware or in software or a combination thereof.

The host controller may be realized in hardware and may be configured to control data transmission between a host stack and at least one apparatus coupled with the host controller. For instance, the host controller may be associated with a driver, wherein this driver may be configured to expose an application program interface (API) for the host controller. The multiplexing entity is configured to handle accesses from the host stacks to the host controller based on the access rules. These accesses may comprise any accesses or access requests from any of the host stacks to the host controller. The access rules may be used for a certain way of synchronizing the at least two host stacks such that these host stacks can share the one host controller without conflicts.

Thus, any existing host stack of an engine, wherein this existing host stack is originally intended to be used with one host controller exclusively, can now share this one host controller with further host stacks. Accordingly, for instance, several different engines, each having an own host stack, may access a single one host controller in order to perform data transmission with a further apparatus associated with the host controller.

For instance, the multiplexing entity may allow to expose an API to a first host stack of the at least two host stacks and an API to the further host stacks that is identical to the above mentioned API of the driver associated with the host controller, i.e. the host stacks will not see the existence of the other stack and the multiplexing entity.

For instance, a mobile device may comprise a modem engine for accessing a 2G mobile network (e.g. GSM) and/or a 3G network (e.g. UMTS) or for any other mobile radio function, wherein this modem engine has to perform access to a smart card unit, e.g. a SIM card, in order give access to a network associated with the mobile device or to other functions of the mobile device by providing authentication. The access from the modem engine to the smart card unit may be realized by a serial data transmission, wherein a host controller for this serial data transmission is placed in the mobile device and the smart card unit is configured to be plugged into an interface of the mobile device in order to be coupled with the host controller. In this case, the mobile device may act as a host and the connected smart card unit acts as a device.

For instance, this smart card unit may represent a Universal Integrated Circuit Card (UICC) implemented according to or substantially based on ETSI TS 102 221 (Release 7, Version 7.9.0, 2007-07).

The mobile device may comprise a further engine besides the modem engine, wherein this further engine may represent an application engine configured to perform applications on the mobile device. This application engine may also have to perform access to the smart card unit, e.g. in order for transferring files or Internet Protocol (IP) traffic or any other type of data traffic.

For instance, a first host stack of the at least two host stacks may represent a host stack associated with the modem engine and a second host stack of the at least two host stacks may represent a host stack associated with the application engine, wherein both the first host stack and second host stack may use the one host controller in order to perform access to a smart card unit coupled to this host controller.

Thus, several engines with several host controllers may be allowed to have access for data transfer to a single one apparatus coupled to the host controller by means of the multiplexing entity which is configured to handle these accesses to the host controller (and thus to an apparatus coupled to the host controller) based on access rules.

Accordingly, for example, different operating systems (OS) may be used for the several engines, and despite these different OS the common host controller can be used in an easy way by means of the multiplexing entity.

According to an embodiment of the present invention, said access rules comprise prioritizing rules for the at least two host stacks.

For instance, these prioritizing rules may comprise a prioritizing range of the at least two host stacks, and the multiplexing entity may be configured to used apply these rules in order to avoid access violation of data transfer from different host stacks to the host controller.

For example, one of the at least two host stacks may represent a master host stack and the at least one remaining host stack may represent at least one slave host stack, so that the master host stack and the at least one slave host stack are handled by the one multiplexing entity based on the prioritizing rules. For instance, the handling based on the prioritizing rules could be according to following rules: first in-first serve; priority list; random; round robin or any other known methods.

According to an embodiment of the present invention, one host stack of said at least two host stacks represents a master host stack and each of the at least one remaining stack represents a slave host stack.

Thus, the host stack representing a master host stack may be provided with a master functionality. E.g., this master functionality may allow preferred access to the host controller compared to the remaining host stacks being provided with slave functionality. For instance, the master host stack may be allowed to perform certain setups of the transfer.

According to an embodiment of the present invention, the multiplexing entity is configured to perform a starting procedure for configuring a data transmission to an apparatus associated with the host controller, said starting procedure comprising: first initializing data transmission between the master host stack and the apparatus via the host controller; and then initializing data transmission between the at least one remaining slave host stack and the apparatus.

Thus, for instance, the master host stack may first initialize data transmission needed by the host stack, wherein this initializing is performed by routing the initializing requests via the multiplexing entity to the host controller.

Afterwards, the at least one slave host stack may start initializing data transmission. During this initializing the multiplexing entity may decide whether routing to the host controller is switched on or is switched off. In case the routing is switched off, the multiplexing entity may provide a local response to the respective slave host controller.

According to an embodiment of the present invention, said apparatus is configured to provide at least one class, and said first initializing comprises initializing data transmission for at least one class of said at least one class by routing initializing data between the master host stack and the apparatus via the host controller.

As a non-limiting example, this apparatus may represent the above mentioned UICC and may offer a Smart Card Class in order to transfer of SIM APDU as well as further classes. For instance, these further classes may comprise a Mass Storage Class configured to access a mass memory on the UICC and/or a kind of IP traffic class configured to transfer IP traffic. Of course, the smart card unit may offer further classes. Thus, the smart card unit may be considered to represent a component class smart card.

For example, assuming that there are several classes associated with the apparatus coupled to the host controller, the access rules may comprise rules for dedicated classes of the several classes. Thus, there may exist a list comprising at least one class which allows routing in case an access request for one of this at least one class is received. Of course, there may exist any other kind of rules for deciding whether an access request is to be routed to the host controller.

The master host stack and the at least one slave host stack may be configured to use the USB Interfaces on the UICC that are dedicated exclusively to them.

For instance, the master host stack is associated with an modem engine and will address those endpoints that are dealing with the Smart Card Class, whereas the at least one slave host stack may be responsible for addressing the endpoints related to Mass Storage Class and/or USB IP Class. The multiplexing entity may be configured to route traffic related to those endpoints from the stacks to the UICC and vice versa.

According to an embodiment of the present invention, said initializing data transmission between the at least one remaining slave stack and the apparatus comprises: selecting a class to be initialized for a slave host stack; checking whether this selected class has already been initialized, and in case this selected class has already been initialized, generating a local response to the slave host stack based on information obtained by previous calls initialization, and in case this selected class has not been initialized, initializing data transmission for this class by routing initializing data between the slave host stack and the apparatus via the host controller.

On startup, the multiplexing unit may signal a connection to the master host stack. Then, the master host stack may initialize the hardware associated with the master host stack. For instance, in case the master host stack is associated with a modem engine of a mobile device, this hardware may represent the USB hardware on modem side.

Then, the activated master host stack may begin to enumerate a first class of the at least one device class of the apparatus coupled to the host controller in order to initialize this class. For instance, in case the apparatus represents the UICC, this first class may be the Smart Card or Mass Storage Class.

The multiplexing entity may receive this request for initialization and routes this request to a host controller driver of the host controller in order to enable the endpoints dealing with this first class. Assuming a USB connection, these activities are happening on a control endpoint like endpoint 0 (EP0) or default control pipe, the multiplexing entity will not filter out any of these.

When the initialization of the first class has been finished, the multiplexing entity may check whether there is a request for another class to be initialized from the master host stack. E.g., assuming that the apparatus represents the UICC, the master host stack might send a request for initializing the Smart Card Class. Thus, at this point the method will proceed with initializing the Smart Card Class as second class in order to enumerate the endpoints dealing with Smart Card Class, wherein the multiplexing entity will not filter out any of the access from the mast host stack.

Then, after this second class has been initialized, and if no request for another class to be initialized is received from the master host stack, then initialization of classes associated with the master host stack is terminated.

Up to this point the multiplexing entity might not signal any connection to any of the at least one slave host stacks.

Then, for instance, it may be checked whether there is another slave host stack coupled to the multiplexing entity. If such a slave host stack exists, initializing hardware associated with this selected slave host stack may start. For instance, this slave host stack may be associated with an application engine.

As mentioned above, the multiplexing entity may receive a request for initializing a class to be used by the selected slave host stack. Now it may be checked whether this requested class has already been initialized. For instance, in case the apparatus represents an UICC and the selected class may represent Smart Card Class or Mass Storage Class, this class may have already been initialized by the master host stack, so that it is proceeded with no routing to the host controller but with generating a response to the selected slave host stack based on information obtained by the previous initialization of this class. In this exemplary case, a device proxy may send a copy of the UICC's descriptors of the responses that the UICC has been sending to the master host stack.

Then, for instance, the slave host stack may request initialization of the Mass Storage Class and/or the USB IP Class, so that the method jumps back to the check whether the new selected class already has been initialized. Since these classes have not been initialized previously, these classes are initialized by routing these access requests for this initialization via the multiplexing entity to the host controller in order to enumerate the endpoints dealing with Mass Storage Class and/or USB IP Class.

If there are no further classes to be initialized and no further slave host stacks, the starting procedure may terminate.

According to an embodiment of the present invention, the multiplexing entity is configured to filter operations to dedicated requests from the at least two host stacks.

These filter operations may be used to decide whether an access request is to be routed to the host controller. Thus, for instance, requests which allow routing may be defined, and, on the other hand, request which don't allow routing may be defined, thereby defining said dedicated request.

For instance, the apparatus coupled to the host controller may offer different classes via different functional interfaces to the host controller. As a non-limiting example, this apparatus may represent the above mentioned UICC and may offer a Smart Card Class in order to transfer of SIM APDU as well as further classes. For instance, these further classes may comprise a Mass Storage Class configured to access a mass memory on the UICC and/or a kind of IP traffic class configured to transfer IP traffic. Of course, the smart card unit may offer further classes. Thus, the smart card unit may be considered to represent a component class smart card.

For example, assuming that there are several classes associated with the apparatus coupled to the host controller, the access rules may comprise rules for dedicated classes of the several classes. Thus, there may exist a list comprising at least one class which allows routing in case an access request for one of this at least one class is received. Of course, there may exist any other kind of rules for deciding whether an access request is to be routed to the host controller.

In case the access request is to be routed to the host controller, the multiplexing entity may perform this routing to the host controller. This routing may comprise a kind of serialization for the case that several routing access from several of the host stacks are received. For instance, this serialization may be applied such that a request from one host stack is put on hold until another request from another host stack has been completed.

According to an embodiment of the present invention, the multiplexing entity is configured to decide whether an access request is to be routed to the host controller or not, and wherein the multiplexing entity is configured to route the access request to the host controller in case it is decided to route.

The multiplexing entity may receive an access request to the host controller by one of the at least two host stacks, wherein this access request may represent an access request for establishing access to an apparatus coupled to the host controller.

Then, it is decided whether this access request is to be routed to the host controller. This decision is performed on basis of the above mentioned access rules.

According to an embodiment of the present invention, the multiplexing entity is configured to generate a local response to the respective host stack in case it is decided not to route the access request.

Furthermore, depending on the access request, it may be decided not to route that access request to the host controller. For instance, the access request from one of the at least two host stacks may be refused in case this access request is associated with a functionally interface used by another host stack. This may be assigned statically, i.e. functional interfaces of the apparatus may be assigned to stacks statically, or this may be done dynamically. E.g., a first access request for one interface may bind this interface upon this interface being used again. Such a non-availability may be indicated to the respective host stack.

Furthermore, as an example, one of the at least two host stacks may represent a master host stack and the at least one remaining host stack may represent a slave host stack.

Under this exemplary assumption, the master host stack may be allowed to perform dedicated control accesses to the host controller. In case one of the slave host stack requests such a dedicated control access to the host controller, this access request may be filtered and the multiplexing entity thus might generate a local response for this slave host stack. Thus, the multiplexing entity might return an answer back to the stack on behalf of the apparatus coupled with the host controller. For instance, the multiplexing entity may comprise a device proxy configured to generate these local responses.

Furthermore, depending on the access request, it may be decided not to route that access request to the host controller. For instance, the access request from one of the at least two host stacks may be refused in case this access request is associated with a functionally interface used by another host stack. This may be assigned statically, i.e. functional interfaces of the apparatus may be assigned to stacks statically, or this may be done dynamically. E.g., a first access request for one interface may bind this interface upon pipe is open again. Such a non-availability may be indicated to the respective host stack.

According to an embodiment of the present invention, the host controller is configured to control data transmission between said at least two host stacks and an apparatus coupled to the host controller, said apparatus providing at least one class for data transmission, and wherein said access rules comprises access rules for at least one of said at least one class.

According to an embodiment of the present invention, said serial data transmission represents a Universal Serial Bus connection.

According to an embodiment of the present invention, said access rules comprise rules for filtering access requests of control transfers via a control pipe.

For instance, assuming a USB connection, traffic on endpoint 0, i.e. EP0) of USB transmission, the control endpoint dealing with the whole USB link, needs to be shared between the master host stack and the at least one slave host stack. This traffic on EP0) is filtered by the multiplexing entity, and it may be checked case by case whether an EP0) access request is routed to the host controller or a local response is generated.

According to an embodiment of the present invention, said apparatus represents a smart card unit.

According to an embodiment of the present invention, a first host stack of the at least two host stacks represents a host stack of an modem engine of a mobile device and a second host stack of the at least two host stacks represents a host stack of an application engine of this mobile device.

The access from the modem engine to the smart card unit may be realized by a USB data transmission, wherein a USB hardware host controller may be placed in the mobile device and the smart card unit is configured to be plugged into an interface of the mobile device in order to be coupled with the host controller.

The application engine may also have to perform access to the smart card unit, e.g. in order for transferring files when using an USB Mass Storage Application and/or Internet Protocol (IP) traffic when using an USB IP Application. This data transfer is achieved by using the same USB host controller as used by the USB host stack of the modem engine, wherein the USB Class Driver and/or the USB IP Class Driver communicate via the USB host stack of the application engine, the multiplexing entity and the USB host controller with the smart card unit.

This may allow that new class drivers can be introduced, e.g. at the application engine as well at the modem engine side, in order to communicate with the respective new class of a smart card unit without changes in hardware, as the single one USB host controller can be used for several USB host stacks and their associated drivers by means of the multiplexing entity, because support of additional USB classes on the smart card unit does not affect the API between modem side and application side at all. For instance, new access rules for the new class would have to be added to the multiplexing entity.

On application side, a more or less unchanged USB host stack can be used for several class drivers. Furthermore, API between modem and application side does not depend on the operating system used on the application side.

Thus, several engines with several host controllers may be allowed to have access for data transfer to a single one smart card unit coupled to the host controller by means of the multiplexing entity which is configured to handle these accesses to the host controller (and thus to an apparatus coupled to the host controller) based on access rules.

It has to be noted that the invention is not restricted to UICC/USB but can be applicable to any other interface where a host controller is accessed from several host stacks.

These and other aspects of the invention will be apparent from and elucidated with reference to the embodiments described hereinafter.

### BRIEF DESCRIPTION OF THE FIGURES

In the figures show:

FIG. 1: a schematic block diagram of a first exemplary embodiment of the present invention;

FIG. 2: a schematic flowchart of a first exemplary embodiment of a method according to the present invention;

FIG. 3: a schematic flowchart of a second exemplary embodiment of a method according to the present invention;

FIG. 4: a schematic block diagram of a second exemplary embodiment of the present invention;

FIG. 5a: a schematic flowchart of a third exemplary embodiment of a method according to the present invention;

FIG. 5b: a schematic flowchart of a fourth exemplary embodiment of a method according to the present invention; and

FIG. 6: a schematic block diagram of an exemplary system according to the present invention.

### DETAILED DESCRIPTION

In the following detailed description, exemplary embodiments will be described.

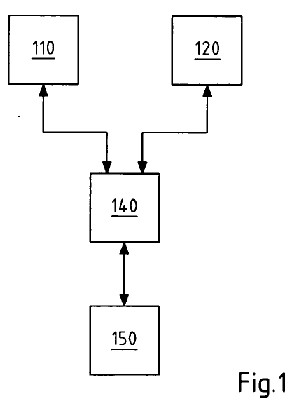

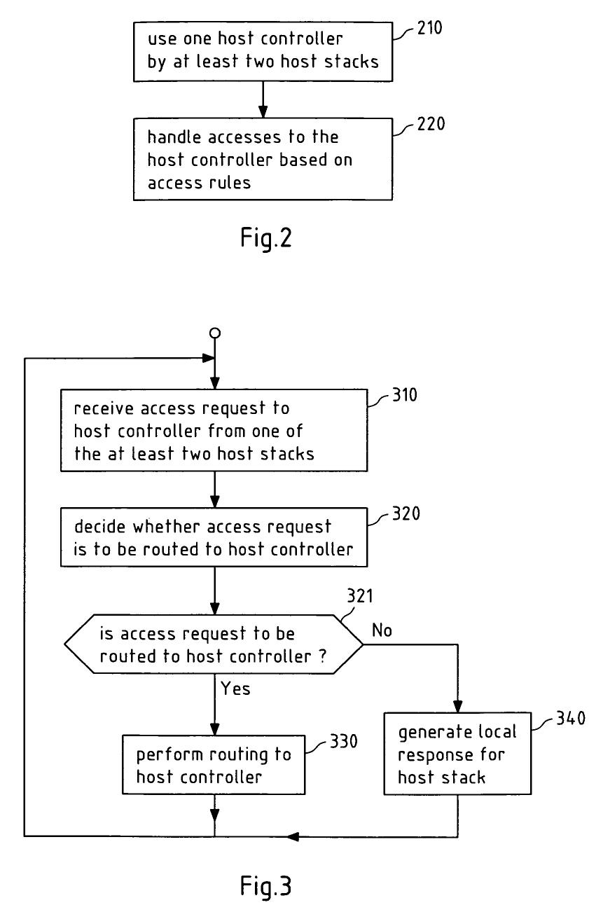

FIG. 1 depicts a schematic block diagram of a first exemplary embodiment of the present invention, wherein a host controller 150 is configured to be used by a first host stack 110 and a second host stack 120 via multiplexing entity 140. The host stacks 110 and 120 and the multiplexing entity 140 may be seen as functional entities, wherein these entities 110, 120 and 140 may be realized in hardware or in software or a combination thereof. This first exemplary embodiment depicted in FIG. 1 will now be explained in conjunction with the schematic flowchart of a first exemplary embodiment of a method depicted in FIG. 2. Although only two host stacks 110, 120 are depicted in FIG. 2, the single one host controller 150 may be used by more than these two host stacks 110, 120.

The host controller 150 may be realized in hardware or in software and may be configured to control data transmission between a host stack and at least one apparatus (not depicted in FIG. 1). For instance, the host controller 150 may be associated with a driver (not depicted in FIG. 1), wherein this driver may be configured to expose an application program interface (API) for a host controller.

The multiplexing entity 140 is configured to handle accesses from the host stacks 110, 120 to the host controller 150 based an access rules. These accesses may comprise any accesses or access requests from any of the host stacks 110, 120 to the host controller 150. The access rules may be used for a certain way of synchronizing both host stacks 110, 120 such that these host stacks 110, 120 can share the one host controller 150 without conflicts.

Thus, any existing host stack of an engine, wherein this existing host stack is originally intended to be used with one host controller exclusively, can now share this one host controller with further host stacks. Accordingly, for instance, several different engines, each having an own host stack, may access a single one host controller 150 in order to perform data transmission with a further apparatus associated with the host controller 150.

For instance, the multiplexing entity 140 may allow to expose an API to both host stacks 110, 120 that is similar or even identical to the above mentioned API of the driver associated with the host controller 150, i.e. the host stacks 110, 120 will not see the existence of the other stack and the multiplexing entity 140.

For instance, a mobile device may comprise a modem engine for accessing a 2G mobile network (e.g. GSM) and/or a 3G network (e.g. UMTS) or for any other mobile radio function, wherein this modem engine has to perform access to a smart card unit, e.g. a SIM card, in order to give access to a network associated with the mobile device or to other functions of the mobile device by providing authentication. The access from the modem engine to the smart card unit may be realized by a serial data transmission, wherein a host controller 150 for this serial data transmission is placed in the mobile device and the smart card unit is configured to be plugged into an interface of the mobile device in order to be coupled with the host controller 150. In this case, the mobile device may act as a host and the connected smart card unit acts as a device.

The mobile device may comprise a further engine besides the modem engine, wherein this further engine may represent an application engine configured to perform applications on the mobile device. This application engine may also have to perform access to the smart card unit, e.g. in order for transferring files or Internet Protocol (IP) traffic or any other data traffic.

For instance, the first host stack 110 may represent a host stack 110 associated with the modem engine and the second host stack 120 may represent a host stack 120 associated with the application engine, wherein both the first host stack 110 and second host stack 120 may use the one host controller 150 in order to perform access to a smart card unit coupled to this host controller 150, as exemplarily indicated by reference sign 210 in FIG. 2.

For example, the first host stack 110 and second host stack 120 stack may be handled by the one multiplexing entity 140 based on prioritizing rules. For instance, the handling based on the prioritizing rules could be according to following rules: first in-first serve; priority list; random; round robin or any other known methods.

Thus, several engines with several host stacks may be allowed to have access for data transfer to a single one apparatus coupled to the host controller 150 by means of the multiplexing entity 140 which is configured to handle these accesses to the host controller 150 (and thus to an apparatus coupled to the host controller 150) based on access rules, as exemplarily indicated by reference sign 220 in FIG. 2.

Accordingly, for example, different operating systems (OS) may be used for the several engines, and despite these different OS the common host controller 150 can be used in an easy way by means of the multiplexing entity 140.

The explanations described above with respect to the first exemplary embodiment in FIG. 1 and the first exemplary method in FIG. 2 also hold for the following exemplary embodiments and the respective components of these embodiments.

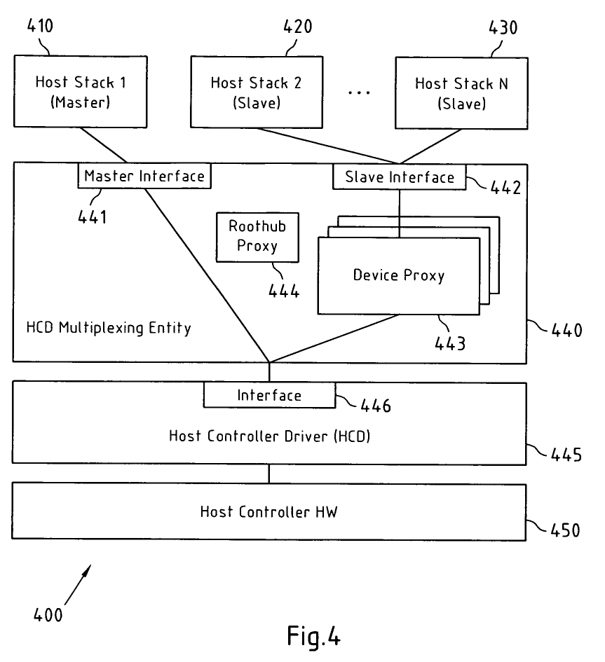

FIG. 3 depicts a schematic flowchart of a second exemplary embodiment of a method according to the present invention.

As exemplarily indicated by reference sign 310 in FIG. 3, the multiplexing entity 140 may receive an access request to the host controller 150 by one of the at least two host stacks, wherein this access request may represent an access request for establishing access to an apparatus coupled to the host controller 150, as described in context of the first exemplary method.

Then, as exemplarily indicated by reference sign 320 in FIG. 3, it is decided whether this access request is to be routed to the host controller. This decision is performed based on the above mentioned access rules.

For instance, the apparatus coupled to the host controller 150 may offer different classes via different functional interfaces to the host controller 150. As a non-limiting example, this apparatus may represent the above mentioned UICC and may offer a Smart Card Class in order to transfer of SIM APDU as well as further classes. For instance, these further classes may comprise a Mass Storage Class configured to access a mass memory on the UICC and/or a kind of IP traffic class configured to transfer IP traffic. Of course, the smart card unit may offer further classes. Thus, the smart card unit may be considered to represent a component class smart card.

For example, assuming that there are several classes associated with the apparatus coupled to the host controller, the access rules may comprise rules for dedicated classes of the several classes. Thus, there may exist a list comprising at least one class which allows routing in case an access request for one of this at least one class is received. Of course, there may exist any other kind of rules for deciding whether an access request is to be routed to the host controller 150.

In case the access request is to be routed to the host controller, the multiplexing entity 140 may perform this routing to the host controller, in accordance with reference signs 321 and 330 of the exemplary method depicted in FIG. 3. This routing may comprise a kind of serialization for the case that several routing access requests from several of the host stacks 110, 120 are received. For instance, this serialization may be applied such that a request from one host stack is put on hold until another request from another host stack has been completed.

Furthermore, depending on the access request, it may be decided not to route that access request to the host controller at reference sign 320 of the exemplary method depicted in FIG. 3. For instance, the access request from one of the at least two host stacks may be refused in case this access request is associated with a functional interface used by another host stack. This may be assigned statically, i.e. functional interfaces of the apparatus may be assigned to stacks statically, or this may be done dynamically. E.g., a first access request for one interface may initialize this interface upon this interface being used again. Such a non-availability may be indicated to the respective host stack at reference sign 340 of the method depicted in FIG. 3.

Furthermore, as an example, one of the at least two host stacks may represent a master host stack and the at least one remaining host stack may represent a slave host stack. Assuming this example, the master host stack may be allowed to perform dedicated control accesses to the host controller 150. In case one of the slave host stack requests such a dedicated control access to the host controller 150, this access request might be filtered and the multiplexing entity 140 thus might generate a local response for this slave host stack. This local response may be a fake positive (e.g. OK) or a fake negative response like (e.g. FAIL). Thus, the multiplexing entity 140 will return an answer back to the stack on behalf of the apparatus coupled with the host controller 150. For instance, the multiplexing entity 140 may comprise a device proxy configured to generate these local responses.

More exemplary details for this generating of local responses at step 340 of the method depicted in FIG. 3 will be explained in view of the following exemplary embodiments.

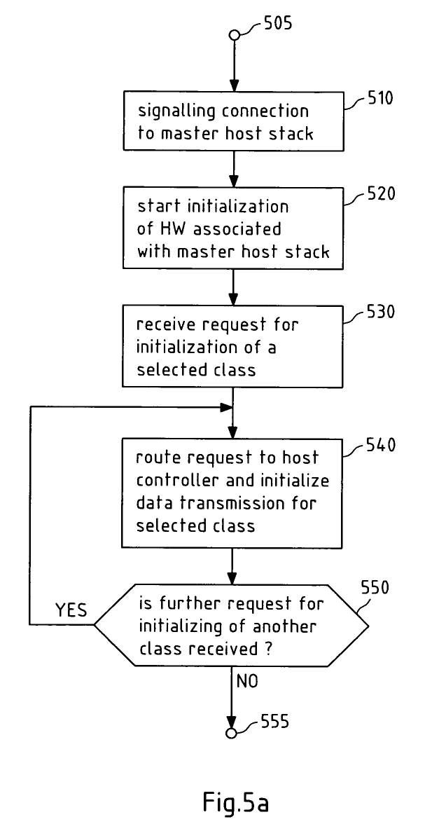

FIG. 4 depicts a schematic block diagram of a second exemplary embodiment 400 of the present invention, wherein this second exemplary embodiment is based on the first exemplary embodiment depicted in FIG. 1.

This second exemplary embodiment 400 comprises one single hardware host controller 450 and a host controller driver (HCD) 445 associated with this host controller 450, wherein the HCD 445 is configured to provide an interface 446 to the multiplexing entity 440. The multiplexing entity 440 is configured to provide a master interface 441 to the master host stack 410 and a slave interface 442 to the at least one slave host stack 420, 430. These interfaces 441 and 442 may represent APIs being semantically identical or at least substantially identical to the API 446 provided by the HCD 445.

The multiplexing entity 440 comprises at least one device proxy 443, wherein each of this at least one device proxy 443 may be configured to decide whether a received access request is to be routed to the host controller 450, and, in case the request is to be routed, the respective device proxy 443 performs this routing to the host controller 450, or, in case the request is not to be routed, the respective device proxy 443 may generate a local response for the respective slave host stack.

As an example without any restrictions, the apparatus coupled to the host controller 450 may represent an USB UICC supporting multiple functional interfaces, wherein this USB UICC represents a composite USB device having a single USB device address. I.e., in case a UICC supports e.g. IP traffic via USB and USB Mass Storage Class. The master host stack 410 and the at least one slave host stack 420, 430 are configured to use the USB Interfaces on the UICC that are dedicated exclusively to them.

For instance, the master host stack 410 is associated with a modem engine and will address those endpoints that are dealing with the Smart Card Class, whereas the at least one slave host stack 420, 430 may be responsible for addressing the endpoints related to Mass Storage Class or USB IP Class. The multiplexing entity 440 is configured to route traffic related to those endpoints from the stacks 410, 420, 430 to the UICC and vice versa.

Endpoint 0 (EP0) is a special case as it may be used to perform USB control requests to the USB device itself and e.g. may not be bound to a specific functional interface. Thus EP0 needs to be shared between the master host stack 410 and the at least one slave host stack 420, 430. This traffic on EP0 is filtered by the multiplexing entity 440, and it may be checked case by case whether an EP0) access request is routed to the host controller 450 or a local response is generated. Furthermore, the exemplary embodiment depicted in FIG. 4 may comprise a roothub proxy 444 configured to generate a local response to a host stack upon an access to the roothub is received.

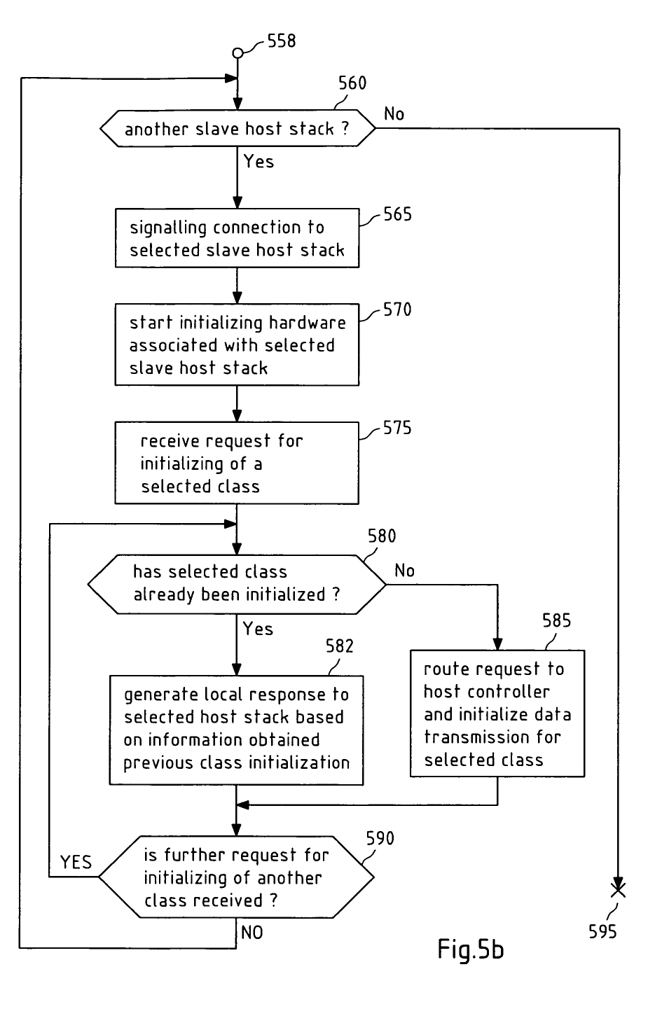

FIG. 5a depicts a schematic flowchart of a third exemplary embodiment of a method according to the present invention.

This third exemplary embodiment describes a part of a starting procedure for configuring a data transmission to an apparatus associated with the host controller 450. It is assumed that the apparatus provides at least one device class. For instance, said apparatus may represent the above mentioned UICC or any other device offering at least one device class.

This third exemplary embodiment of a method depicted in FIG. 5a will now be described in conjunction with the second embodiment depicted in FIG. 4, but of course the first embodiment depicted in FIG. 1 could also be used.

Reference sign 505 indicates that startup of the device comprising second embodiment 400. For instance, this device may represent a mobile terminal or mobile phone or any other type of device using a subscriber identity module.

On startup 505, the multiplexing unit 440 signals a connection to the master host stack 410, as indicated by reference sign 510 in FIG. 5a. Then, the master host stack initializes the hardware associated with the master host stack 410, as indicated by reference sign 520. For instance, in case the master host stack is associated with a modem engine of a mobile device, this hardware may represent the USB hardware on modem side.

Then, the activated master host stack 410 may begin to enumerate a first class of the at least one device class of the apparatus coupled to the host controller 450 in order to initialize this class. In case the apparatus represents the UICC, this first class may be the Smart Card Class or Mass Storage Class.

The multiplexing entity 440 receives this request for initialization (step 530 depicted in FIG. 5a) and routes this request to the host controller driver (HCD) 445 of the host controller (step 540) in order to select this first class and in order to possibly enable endpoints related to that class. Assuming a USB connection, these activities are happening on the EP0, the multiplexing entity 440 will not filter out any of these.

When the initialization of the first class has been finished, the multiplexing entity may check whether there is a request for another class to be initialized from the master host stack 410, as indicated by reference sign 550 in FIG. 5a. Assuming that the apparatus represents the UICC, the master host stack will send a request for initializing the interfaces of the Smart Card Class. Thus, at this point the method will proceed with initializing the interfaces of the Smart Card Class as second class during step 540.

Then, after this second class has been initialized, and if no request for another class to be initialized is received from the master host stack 410, then initialization of classes associated with the master host stack 410 is terminated, as indicated by reference sign 555. Up to this point the multiplexing entity 440 will not signal any connection to any of the at least one slave host stacks 420, 430.

After this third exemplary method has been finished, it may be succeeded by the fourth exemplary method at starting point 558 depicted in FIG. 5b.

At first it may be checked whether there is another slave host stack coupled to the multiplexing entity, as indicated by reference sign 560. If such a slave host stack exists, e.g. slave host stack 420, a connection is signaled to the selected slave host stack (step 565), and initializing hardware associated with this selected slave host stack 420 may start at step 570. For instance, this slave host stack 420 may be associated with an application engine. This step may be optional as the hardware may be already initialized. This request may be filtered and just a local response to the slave host stack may be generated.

As mentioned above in respect to step 530, the multiplexer receives a request for initializing a class to be used by the selected slave host stack 420 (step 575). Now it is checked whether this requested class has already been initialized. For instance, in case the apparatus represents an UICC and the selected class may represents the Smart Card or Mass Storage Class, this class has already been initialized so that the method proceeds with no routing to the host controller 450 but with generating a response to the selected slave host stack 420 based on information obtained by the previous initialization of this class (step 582). In this exemplary case, a device proxy 443 may send a copy of the UICC's descriptors of the responses that the UICC has been sending to the master host stack.

Then, for instance, the slave host stack 420 may request initialization of the Mass Storage Class and/or the USB IP Class (step 590), so that the method jumps back to the check whether the new selected class already has been initialized (step 580). Since these classes have not been initialized previously, these classes are initialized at step 585, wherein the multiplexing entity 440 routes these access requests for this initialization to the HCD 445 of the host controller 450 in order to enumerate the endpoints dealing with Mass Storage Class and/or any other type of class.

If there are no further classes to be initialized and no further slave host stacks, the method may terminate at point 595.

Once the master host stack 410 and the at least one slave host stack 420 are running, they will be addressing their exclusively assigned endpoints. If they send EP0) request still, they are normally related to those endpoints, and these requests will not be filtered out by the multiplexing entity 440 at steps 320 and 321 of the exemplary method depicted in FIG. 3, so that these request are routed to the respective endpoints via the host controller (step 330 in FIG. 3). In case one of the stacks sends an EP0) request that is not related to its endpoints, the multiplexing entity 440 will provide some filtering again and thus may proceed with step 340 depicted in FIG. 3.

Thus, additional USB classes on the UICC can be used with the at least one further slave host stack via the slave interface 442 without affecting the API 441 between the master host stack 410 and the multiplexing entity 440.

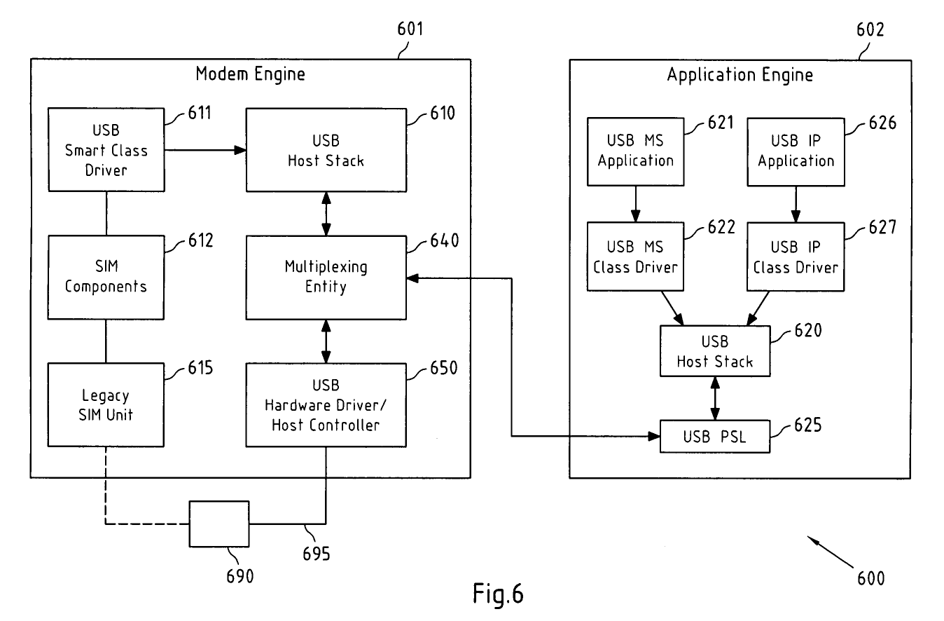

FIG. 6 depicts a schematic block diagram of an exemplary system according to the present invention.

This system 600 depicts an architecture configured to be used by a mobile device, e.g. a mobile terminal or any other type of device using a subscriber identity module or the like.

This architecture comprises a modem engine 601, which may be configured for accessing a 2G mobile network (e.g. GSM) and/or a 3G network (e.g. UMTS) or for any other mobile radio functions, wherein this modem engine has to perform access to a smart card unit 690, e.g. a SIM card, in order give access to a network associated with the mobile device or to other functions of the mobile device by providing authentication.

The access from the modem engine to the smart card unit may be realized by a USB data transmission, wherein a USB hardware host controller 650 is placed in the mobile device and the smart card unit 690 is configured to be plugged into an interface of the mobile device in order to be coupled with the host controller 650, which is indicated by the connection line 695 in FIG. 6. Then, the SIM components 612 may communicate with the USB Smart Class Driver 611 and USB host stack 610 via the multiplexing entity 640 and the USB hardware driver 650 as mentioned before. Furthermore, the mobile device may comprise a legacy SIM unit 615 configured to check legacy of a connected smart card unit 690.

For instance, this smart card unit may represent a Universal Integrated Circuit Card (UICC) implemented according to or substantially based on ETSI TS 102 221 (Release 7, Version 7.9.0, 2007-07).

The mobile device further comprises an application engine 602 besides the modem engine 601, wherein this application engine 602 may represent an application engine 602 configured to perform applications on the mobile device. This application engine 602 may also have to perform access to the smart card unit 690, e.g. in order for transferring files when using the USB Mass Storage Application 621 or Internet Protocol (IP) traffic when using the USB IP Application 626 or any other type of data traffic. This data transfer is achieved by using the same USB host controller 650 as used by the USB host stack 610 of the modem engine 602, wherein the USB Class Driver 622 and/or the USB IP Class Driver 627 communicate via the USB host stack 620 of the application engine, the multiplexing entity 640 and the USB host controller 650 with the smart card unit 690, as mentioned above.

This allows, that new class drivers can be introduced, e.g. at the application engine side as well at the modem engine side, in order to communicate with the respective new class of a smart card unit 690 without changes in hardware, as the single one USB host controller can be used for several USB host stacks 610, 620 and their associated call drivers 611, 621, 626 by means of the multiplexing entity 640, because support of additional USB classes on the smart card unit does not affect the API between modem side and application side at all. For instance, new access rules for the new class may have to be added to the multiplexing entity.

On application side, a more or less unchanged USB host stack 620 can be used for several class drivers. The platform specific layer (PSL) component 625 is used to abstract the hardware and hide the hardware specialties to the layers above. Beside that it may be used to wrap the stack requests to the requests on the API on modem side and if needed serialize them.

Furthermore, API between modem and application side does not depend on the operating system used on the application side. Thus, several engines 601, 602 with several host stacks 610, 620 may be allowed to have access for data transfer to a single one smart card unit 690 coupled to the host controller 650 by means of the multiplexing entity 640 which is configured to handle these accesses to the host controller 150 (and thus to an apparatus coupled to the host controller 150) based on access rules, as exemplarily indicated by reference sign 220 in FIG. 2.

Accordingly, an easy extension of an available architecture without the need of a change in the related chip set API that defines the interfaces of the multiplexing entity is allowed, and there is no need of duplicated logic in the smart card unit.

It is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. Said computer software may be stored in a variety of storage media of electric, magnetic, electro-magnetic or optic type and may be read and executed by a processor, such as for instance a microprocessor. To this end, said processor and said storage medium may be coupled to interchange information, or the storage medium may be included in the processor.

The invention has been described above by means of exemplary embodiments. It should be noted that there are alternative ways and variations which are obvious to a skilled person in the art and can be implemented without deviating from the scope and spirit of the appended claims. In particular, the invention is not restricted to UICC/USB but can be applicable to any other interface where a host controller is accessed from several host stacks.

What is claimed is:

1. A method, comprising:
using one host controller by at least two host stacks; and
handling accesses to the host controller based on access rules.

2. The method of claim 1, said access rules comprising prioritizing rules for the at least two host stacks.

3. The method of claim 2, wherein one host stack of said at least two host stacks represents a master host stack and each of the at least one remaining stack represents a slave host stack.

4. The method of claim 3, comprising a starting procedure for configuring a data transmission to an apparatus associated with the host controller, said starting procedure comprising:
first initializing data transmission between the master host stack and the apparatus via the host controller; and
then initializing data transmission between the at least one remaining slave host stack and the apparatus.

5. The method of claim 4, wherein said apparatus is configured to provide at least one class, and wherein said first initializing comprises initializing data transmission for at least one class of said at least one class by routing initializing data between the master host stack and the apparatus via the host controller.

6. The method of claim 5, wherein said initializing data transmission between the at least one remaining slave stack and the apparatus comprises:
selecting a class to be initialized for a slave host stack;
checking whether this selected class has already been initialized, and
in case this selected class has already been initialized, generating a local response to the slave host stack based on information obtained by previous calls initialization, and
in case this selected class has not been initialized, initializing data transmission for this class by routing initializing data between the slave host stack and the apparatus via the host controller.

7. The method of claim 1, wherein said handling accesses comprises filtering operations to dedicated requests from the at least two host stacks.

8. The method of claim 7, comprising deciding whether an access request is to be routed to the host controller or not, and routing the access request to the host controller in case it is decided to route.

9. The method of claim 8, wherein in case it is decided not to route the access request, generating local response to the respective host stack.

10. The method of claim 7, wherein the host controller is configured to control data transmission between said at least two host stacks and an apparatus coupled to the host controller, said apparatus providing at least one class for data transmission, and wherein said access rules comprises access rules for at least one of said at least one class.

11. The method of claim 10, wherein said serial data transmission represents a Universal Serial Bus connection.

12. The method of claim 7, wherein said access rules comprises rules for filtering access requests of control transfers via a control pipe.

13. The method of claim 10, wherein said apparatus represents a smart card unit.

14. The method of claim 1, wherein a first host stack of the at least two host stacks represents a host stack of a modem engine and a second host stack of the at least two host stacks represents a host stack of an application engine.

15. A device, comprising:
one host controller;
at least two host stacks; and
one multiplexing entity configured to use the one host controller by said at least two host stacks and configured to handle accesses to the host controller based on access rules.

16. The device of claim 15, said access rules comprising prioritizing rules for the at least two host stacks.

17. The device of claim 16, wherein one host stack of said at least two host stacks represents a master host stack and each of the at least one remaining stack represents a slave host stack.

18. The device of claim 16, wherein the multiplexing entity is configured to perform a starting procedure for configuring a data transmission to an apparatus associated with the host controller, said starting procedure comprising:
first initializing data transmission between the master host stack and the apparatus via the host controller; and
then initializing data transmission between the at least one remaining slave host stack and the apparatus.

19. The device of claim 18, wherein said apparatus is configured to provide at least one class, and wherein said first initializing comprises initializing data transmission for at least one class of said at least one class by routing initializing data between the master host stack and the apparatus via the host controller.

20. The device of claim 19, wherein said initializing data transmission between the at least one remaining slave stack and the apparatus comprises:
selecting a class to be initialized for a slave host stack;
checking whether this selected class has already been initialized, and
in case this selected class has already been initialized, generating a local response to the slave host stack based on information obtained by previous calls initialization, and
in case this selected class has not been initialized, initializing data transmission for this class by routing initializing data between the slave host stack and the apparatus via the host controller.

21. The device of claim 15, wherein the multiplexing entity is configured to filter operations to dedicated requests from the at least two host stacks.

22. The device of claim 21, wherein the multiplexing entity is configured to decide whether an access request is to be routed to the host controller or not, and wherein the multiplexing entity is configured to route the access request to the host controller in case it is decided to route.

23. The device of claim 22, wherein the multiplexing entity is configured to generate a local response to the respective host stack in case it is decided not to route the access request.

24. The device of claim 21, wherein the host controller is configured to control data transmission between said at least two host stacks and an apparatus coupled to the host controller, said apparatus providing at least one class for data transmission, and wherein said access rules comprises access rules for at least one of said at least one class.

25. The device of claim 24, wherein said serial data transmission represents a Universal Serial Bus connection.

26. The device of claim 21, wherein said access rules comprises rules for filtering access requests of control transfers via a control pipe.

27. The device of claim 24, wherein said apparatus represents a smart card unit.

28. The device of claim 15, wherein a first host stack of the at least two host stacks represents a host stack of a modem engine and a second host stack of the at least two host stacks represents a host stack of an application engine.

29. A device, comprising:
one host controller means;
at least two host stack means; and
one multiplexing means configured to use the one host controller means by said at least two host stack means and configured to handle accesses to the host controller means based on access rules.

30. A system, comprising:
A device according to claim 15; and
an apparatus coupled to the host controller, wherein the host controller is configured to control data transmission between said at least two host stacks and the apparatus.

31. The system of claim 30, wherein the apparatus represents a smart card unit.

32. The system of claim 31, wherein the smart card unit represents a Universal Integrated Circuit Card.

33. A computer-readable storage medium encoded with instructions that, when executed by a computer, perform:
using one host controller by at least two host stacks; and
handling accesses to the host controller based on access rules.

34. The computer-readable storage medium of claim 33, said access rules comprising prioritizing rules for the at least two host stacks.

35. The computer-readable storage medium of claim 34, wherein said instruction, when executed by a computer, perform filtering operations to dedicated requests from the at least two host stacks.
